(19) United States
(12) Patent Application Publication
(10) Pub. No.: US 2011/0174938 A1
(43) Pub. Date: Jul. 21, 2011

(54) Modular Low Profile Swivel Mechanism

(75) Inventors: Rafael Calderon, San Diego, CA (US); Jacob Leven, Huntington Beach, CA (US)

(73) Assignees: SONY CORPORATION, A JAPANESE CORPORATION, Tokyo (JP); SONY ELECTRONICS INC., Parkridge, NJ (US)

(21) Appl. No.: 12/688,820

(22) Filed: Jan. 15, 2010

(51) Int. Cl. F16M 11/04; F16M 13/00; B23P 11/00

(52) U.S. Cl. 248/125.7; 248/299.1; 29/428

(57) ABSTRACT

A swivel mechanism, comprising a base configured to be attached to a screen and further configured to rotate with the screen as the screen is rotated, a hub configured to fit into the base and remain stationary as the screen and the base are rotated and two springs configured to be set into the hub and configured to compress to provide a resistance torque as the screen is rotated.

### BACKGROUND OF THE INVENTION

1. Field of the Invention

The present invention relates generally to mounting devices, and more specifically to a swivel mechanism for use with a screen.

2. Discussion of the Related Art

Flat panel displays have gained popularity due to their compact size and adjustability. These displays are capable of displaying images oriented in both horizontal and vertical orientation. Rotating the display to different orientations, i.e., portrait and landscape can be affected by simply pivoting the display.

### SUMMARY OF THE INVENTION

Several embodiments of the invention advantageously address the needs above as well as other needs by providing a swivel mechanism, comprising a base configured to be attached to a screen and further configured to rotate with the screen as the screen is rotated, a hub configured to fit into the base and remain stationary as the screen and the base are rotated and two springs configured to be set into the hub and configured to compress to provide a resistance torque as the screen is rotated.

In another embodiment, the invention can be characterized as a method of assembling a swivel mechanism comprising providing a base having concentric outer and an inner cylindrical walls, providing a hub, providing two springs, setting the hub into the opening created between the inner and outer walls of the base, and setting the springs into the hub such that each spring is placed at one side of the hub.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1A illustrates the main components of the mechanism, according to several embodiments of the present invention.

FIG. 1B illustrates the manner in which the modular mechanism is assembled, according to one embodiment of the present invention.

FIG. 1C illustrates the overall mechanism after it is fully assembled, according to one embodiment of the present invention.

FIGS. 2A and 2B illustrate one exemplary embodiment of the nylon base 130, according to one embodiment of the present invention.

FIGS. 3A, 3B and 3C illustrate the hub 120 according to one embodiment of the present invention.

FIGS. 4A and 4B illustrate an exemplary embodiment of details of implementation of a rotational limitation, according to one embodiment of the present invention.

FIG. 5 illustrates springs 110a and 110b according to several embodiments of the present invention.

FIGS. 6A and 6B illustrate the mechanism as attached to the screen and the arm assembly, according to one or more embodiments of the present invention.

FIG. 7 illustrates the axial cable channel of the swivel mechanism, according to one embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

As discussed above flat panel displays have gained popularity due to their compact size and adjustability. These displays are capable of displaying images oriented in both horizontal and vertical orientation. Rotating the display to different orientations, i.e., portrait and landscape can be affected by simply pivoting the display. However, this can be problematic, as the display may be rotated to an orientation in between a landscape and portrait orientation and leave the image skewed for the user. Furthermore, if the user is able to rotate or twist the display freely, it may eventually result in an internal cable being twisted to the breaking point.

In one embodiment, the present invention provides a swivel mechanism for use with a display, such as a TV, having a total of 360 degrees of freedom between the arm and the screen. The mechanism allows the display to rotate 180 degrees in either direction. That is, there is a point along the travel path of the rotating screen, which it can reach from either direction, but never pass. The mechanism, in some embodiments, will cause the display to automatically snap into position at 90-degree intervals around the rotation path. The mechanism, in some embodiments, is designed to provide the user with a relatively constant torque resisting movement as the user rotates the screen. According to some embodiments, a spring-cam system provides a torque resisting rotation as the user rotates the screen and snaps the screen into position at the desired 90-degree intervals.

The mechanism is designed to be compact, easy to assemble and versatile. In one embodiment, the modular rotation mechanism is compartmentalized so that it can be assembled as a unit and inserted into the main assembly, and further be usable in different designs. Further, having a modular mechanism allows the unit to be assembled at a separate facility from the main display, e.g. TV, assembly plant. Still further, the mechanism attachment points to the screen and to the arm are general enough to work with a variety of display designs and cosmetics.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

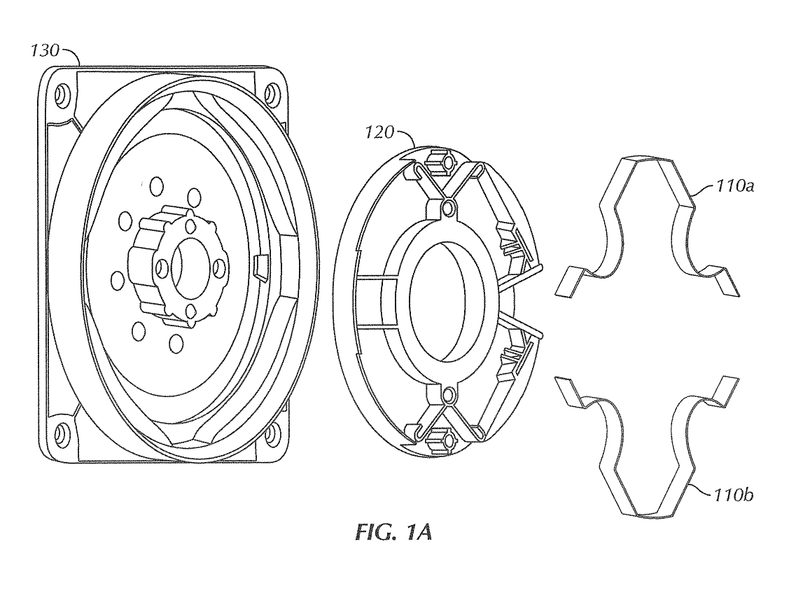

Referring first to FIGS. 1A, 1B and 1C the overall design of the swivel mechanism is illustrated, according to one embodiment.

FIG. 1A illustrates the main components of the mechanism 100, according to several embodiments. The mechanism comprises a set of springs 110a and 110b, a hub 120, and a base assembly 130. FIG. 1B illustrates the manner in which the modular mechanism is assembled, according to one embodiment. The hub 120 sits in the nylon base 130, and in some embodiments, remains stationary as the nylon base rotates with the TV screen. Springs 110a and 110b are fixed into the rotational hub 120. In one embodiment, the mechanism is designed to be as compact as possible. For example, in one embodiment, the mechanism may be as compact as 13 mm thick or less.

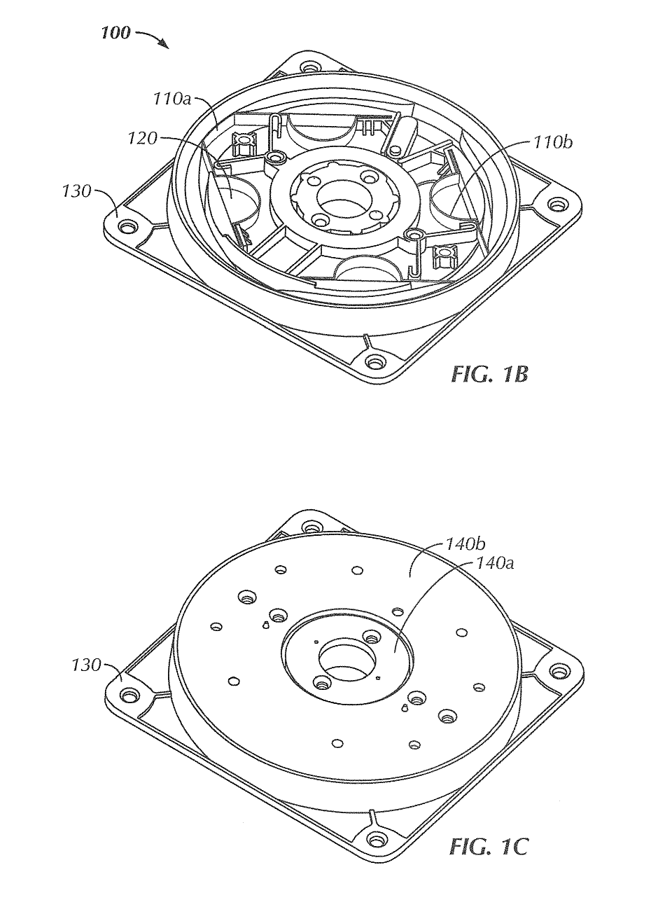

In one embodiment, the nylon base 130 is the structural base of the mechanism. FIG. 2A illustrates one exemplary embodiment of the nylon base 130, according to one embodiment of the present invention. The nylon base 130 is a molded nylon part consisting of roughly two concentric cylinders, outer cylinder 132 and outer cylinder 134 and a thin square plate 136. The inner surface of the outer cylinder 132 is the cam 138. As illustrated in FIG. 2B, in one embodiment, the cam comprises three distinct sections: steady state travel surfaces 210, transition surfaces 220 and snap-to points 230. In an exemplary embodiments, the cam comprise four steady state travel surfaces 210 equally distanced from one another one the 4 sides of the cam. The compression of the springs 110a and 110b is constant as the springs rotate across these surfaces. In one embodiment, the cam further comprise 8 transition surfaces 220 that separate the snap-to points 230 from the steady state travel surfaces 210. As the springs 110a and 110b traverse these transition areas 220, the spring compression changes with position. Furthermore, the cam may also comprise four snap-to points 230 at 90-degree intervals where the screen will lock into position. At these snap-to points the springs are under minimal compression. It should be noted that the number of the surfaces on the cam is proportional to the number of snap-to points or the number of intervals at which the screen should lock into position. That is, as the number of snap to positions increase or decrease in various implementations, the number of each section on the cam will increase or decrease proportionally.

In some embodiments, screw holes are provided to attach the base to the screen. For example, in one embodiment, as illustrated, screw holes are provides at the four corners of the square plate 136 to attach the mechanism to the display screen. In one or more embodiments, the mechanism is designed for a variety of nylon having a coefficient of friction of 0.34 with the steel of the springs. In one or more embodiments, the material may be varied to vary the coefficient of friction. For example, in one or more embodiments, if it is determined that he amount of friction should be increased or decreased, the resin used for the base may be changed to match the desired increased or decreased friction. In addition to the screw holes for attachment to the screen, the base further comprises means for attachment of the inner lid 140a. In one embodiment, for example, there are two screw holes on the inner cylinder 134 of the base for attaching the inner lid. In another embodiment, the inner cylinder 134 may additionally have two cones thereon to make sure that the inner lid is attached right side up.

In one or more embodiments, the thicker sections of the base are cored, and in further embodiments, ribs may be added for structural integrity. In some embodiments, the top surface of the base may be slightly shorter than the top surface of the hub in order to create interference between the hub and the inner lid, making a snug assembly fit.

The hub sits around the inner cylinder of the base feature. In one embodiment, the base comprises a ring of humps around the inner cylinder and the hub sits on the ring of bumps around the cylinder. In one or more embodiments, the bumps prevent the large flat surface of the nylon base from directly contacting the large flat underside of the hub to prevent excessive unwanted friction.

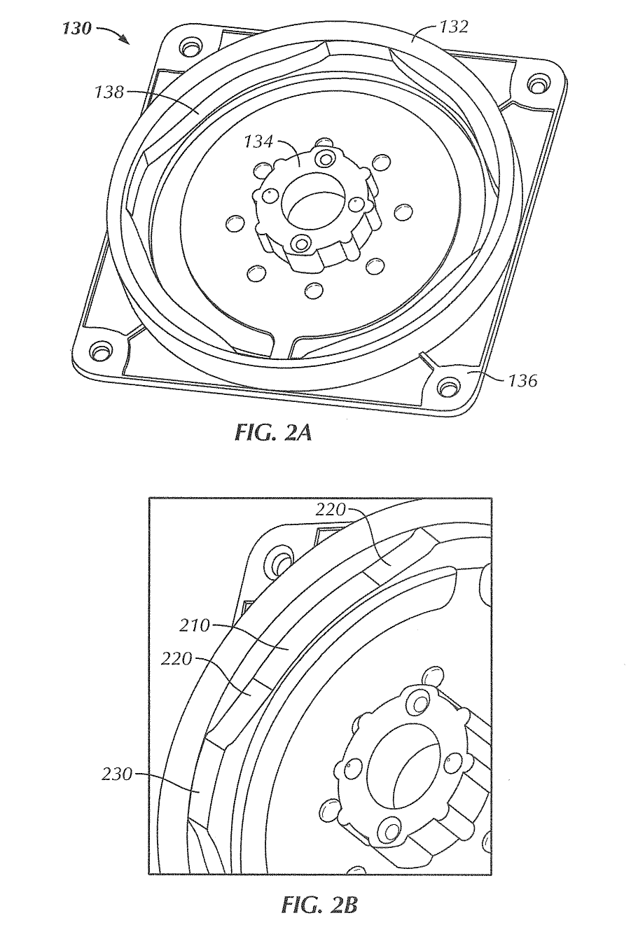

FIGS. 3A, 3b and 3C illustrate the hub 120 according to one embodiment of the present invention. In one or more embodiments, the hub 120 sits in the nylon base and remains stationary as the nylon base rotates with the screen. As illustrated in FIG. 3B, switch 310 is set into the hub and ensures a maximum of 360 degrees of rotational movement. In one or more embodiments, the switch may be removed if it is determined that the mechanism is attached to a display or other entity where a rotational limitation is not desirable.

The hub 120 serves as the attachment point for the springs that follow the nylon base's cam. In one or more embodiments, the hub is designed to restrict the movement of the springs such that the springs deform in a controlled manner under stress. In one embodiment, the hub comprises attachment means for attaching to the TV stand arm. For example, in one embodiment, the hub comprises one or more screw holes for attaching to the TV stand arm. In one example, there are two screw holes located on the hub for attaching to the arm. In yet another embodiment, the hub further comprises attachment points for the outer mechanism lid. In some embodiments, the hub is molded plastic. In one or more embodiments, the underside of the hub may be cored. In additional embodiments, ribs may be added for structural support.

In one embodiment, as illustrated in FIG. 1C, in order to avoid excessive wear and friction, the surfaces of the hub in contact with the springs may be rounded with no sharp edges. In one or more embodiments, the ends may be U shaped in order to create a strong, rounded surface in order to avoid sink marks. In one or more embodiments, the thickness of certain areas of the hub may be varied in order to improve the performance of the mechanism. In one exemplary embodiment, for example, the base thickness is 1.5 mm in some areas in order to accommodate the width of the springs. In one embodiment, other areas may have a base thickness of 2.5 mm in order to avoid sink marks and to increase strength. In one or more embodiments, ribs may also be added to thinner walls where strength may be a concern. In one or more embodiments, a small wall 320 or other means may be provided to prevent the spring from slipping out of place.

In some embodiments, the surfaces of the molded parts of the components, e.g. the base and hub, have a 3-degree draft angle. In some embodiments, selected surfaces, such as ribs may have a higher draft angle such as for example a 5-degree draft angle. In some embodiments, the cam 138, i.e., the internal surface of the outer cylinder of the nylon base 130, has a 1.5 degree draft mold.

In one embodiment, to prevent damage or breaking of the parts, additional ribs may be added to the base or hub. In another embodiment, the thickness of the spring may alternatively or additional be increased. In one embodiment, ribs are added or thickness of one or more parts is increased where there is not concern of sink marks.

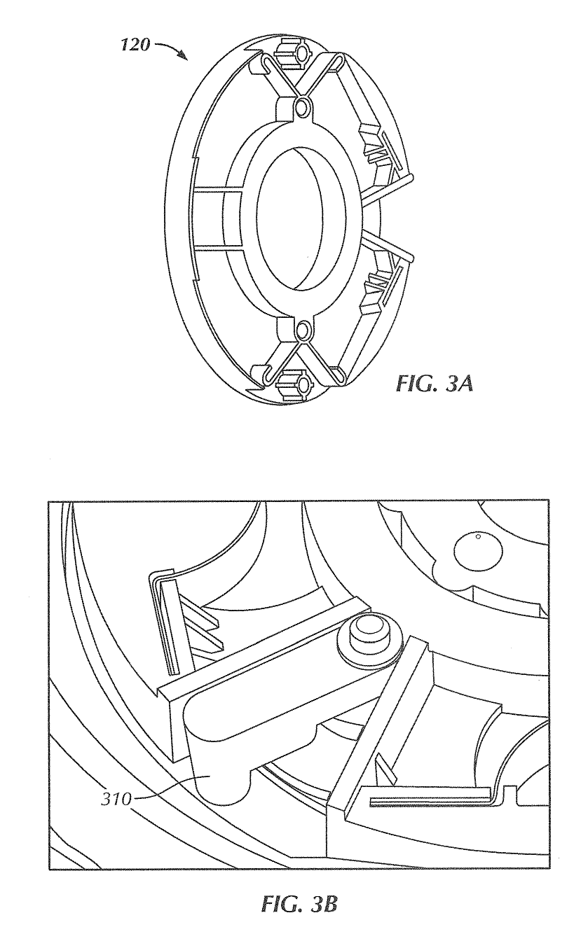

FIGS. 4A and 4B provide a detailed depiction of the manner in which the mechanism implements the rotational limitation described above, in accordance with one embodiment of the present invention. As stated above, in some embodiments, the rotational limit is implemented using a switch 310. For example, as illustrated in FIG. 4A, in one embodiment, a groove 410 extends around most of the nylon base. In some embodiments, a single break 420 in the groove blocks the movement of a switch 310, limiting the rotational freedom of the hub to a total of 360 degrees. As illustrated in FIG. 3B, in one embodiment, the switch sits in the hub 120, and the tip of the switch extends into the nylon base groove 410. FIG. 4B illustrates the switch 310 in extreme and intermediate positions A, B and C. Position A and C depict the switch in the extreme positions at both sides of the break 420 in the groove. In these positions, the break will block the hub from traveling and therefore will limit the rotational movement of the mechanism and the screen beyond a 360-degree traveling path. Position B depicts the switch as the hub is traveling along the base within the 360-degree rotational limit.

In one embodiment in order to avoid the risk of the switch jumping the break in the groove, the connection between the hub 120 and the outer lid 140b may be reinforced. For example, in one possible embodiment, one or more additional screws may be used to reinforce the connection between the hub and the outer lid. In another embodiment, for example, the existing screw holes connecting the hub to the outer lid may be moved closer to the position of the switch to assure that the switch is secure. In such embodiment, an additional screw or other connection means may also be added to reinforce the connection.

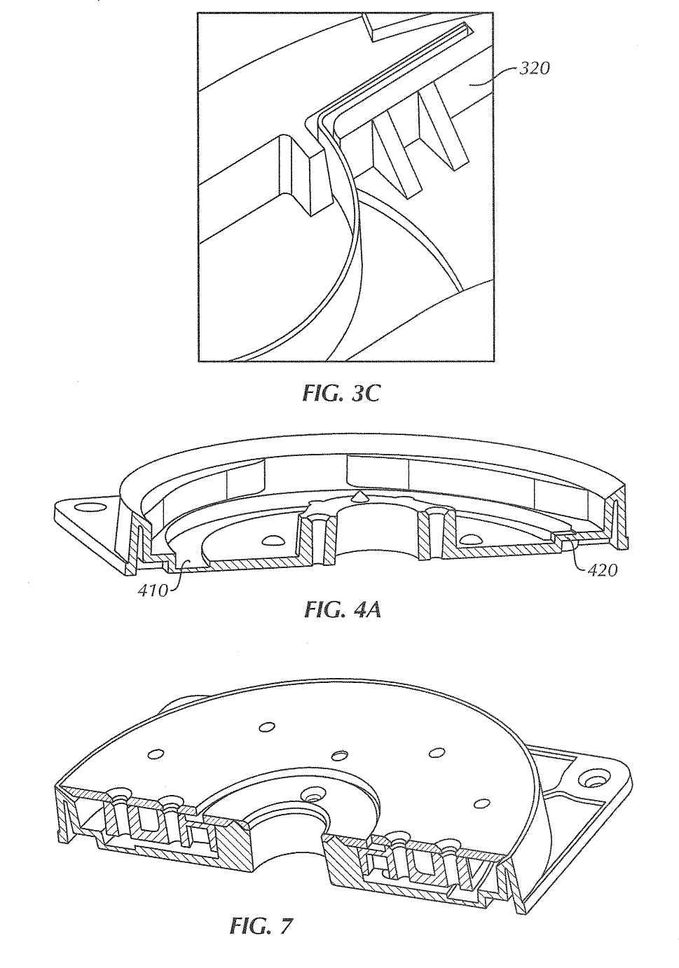

FIG. 5 illustrates springs 110a and 110b according to several embodiments of the present invention. The springs 110a and 110b are designed to provide a desired resistance torque while the screen is being tilted by the user. In one embodiment, the springs 110a and 110b may be manufactured from ribbon spring steel. In one exemplary embodiment, the springs are stamped from 5 mm wide, 0.25 mm thick steel. However, the size and material of the springs may vary according to various considerations. As illustrated in FIG. 5, the spring 110a and 110b comprise 3 distinct parts. The top surface 510 follows the cam 138 of the base 130. The two semicircular sections 520 that comprise the key areas of compression. In one embodiment, the semicircles 520 compress as the rest of the spring remains relatively stiff. In one or more embodiments, the diameter of the semicircular sections defines the desired displacement. The two arms 530 are the portions set into the hub.

In one or more embodiments, several design variations may be applied to the springs. For example, to ensure that the spring is stiff outside of the semicircular compression sections 520, in some embodiments, gussets may be added to the bends of the spring. For example, in one embodiment, there may be too much elastic deformation in the joints connecting the top of the springs to the legs and such gussets may help improve the stiffness of the sections of the springs that are desired to remain stiff. In other embodiments, the corner radii of the springs may be varied to lower stress concentration in order to avoid the corners of the springs from breaking for example as a result of cold working.

According to one or more embodiments, as the springs 110a and/or 110b travel between snap-to-points 230 at 90-degree intervals, they provide a smooth consistent resistance torque against the movement of the screen by the user. In one embodiment, for example, each spring will provide about 750 N-mm of resistance torque, such that in some embodiments, the target resistance torque is about 1500 N-mm. To achieve such a resistance torque, in one or more embodiments certain design considerations must be taken into account. For example, the dimensions of the springs 110a and 110b including the radius of the semicircular sections provide a certain desired displacement, and spring strain.

For example, in one embodiment, the moment arm of the rotation is 42.5 mm. The nylon base is made up of a material such that the coefficient of friction between the nylon and the steel of the spring is roughly 0.34.

T=Torque [N-mm]=750 [N-mm]

r=moment arm [mm]=42.5 [mm]

μ=Coefficient of Friction=0.34

N=Normal Force [N]

F=Friction Force [N]

F=μ*N Friction Equation→N=T/(r*μ)

N=750/(42.5*0.34)=52 [N]

According to these calculations, each spring must press into the nylon cam with a force of 52 newtons during steady state travel. In one embodiment the desire spring displacement of the steady state travel is 4.42 mm, therefore, the spring constant k, is 11.76.

To design a spring and overall swivel mechanism that provides such a resistance torque, several FEA simulations were performed. Forces were applied to the part of the spring in contact with the cam and the spring was appropriately constrained. The radius of the semicircular portions of the spring arms were adjusted until the desired spring constant was reached. The results were analyzed to verify that stress levels were reasonable and spring displacement was within reason.

In one or more embodiments, the design of the springs is varied to adjust the amount of resistance torque provided. In one embodiment, this is achieved by changing the radius of the semicircular sections of the springs. A larger radius decreases the spring constant and consequently the resistance torque while decreasing the radius increases the spring constant, increasing resistance torque. In another embodiment, the thickness of the spring steel stock used to produce the springs may be varied. In some embodiments, using thinner stock would decrease the spring constant and consequently increase the resistance torque and increasing the thickness of the spring steel stock would have the opposite effect. It should be noted that in some embodiments the hub is designed such that the existing hub geometry can easily accommodate a variety of spring thicknesses. In yet another embodiment, the nylon used to produce the nylon base may be changed in order to achieve a different amount of resistance torque. Different nylons provide different nylon to steel coefficient of friction, as such affecting the resulting resistance torque. In some embodiments, such solution is most effective where the torque is an order of magnitude off the desired mark. In another embodiment, the texture of the cam may be changed, which will similarly result in changing the effective friction coefficient between the nylon and steel.

FIG. 1C illustrates the overall mechanism after it is fully assembled, according to one embodiment of the present invention. According to one or more embodiments, a pair of lids 140a and 140b seal the hub and springs into the base. In one or more embodiments, the two concentric lids 140a and 140b seal the mechanism into a convenient package. In one embodiment, for example, the inner lid 140a and the nylon base encase the hub. In one embodiment, the outer lid 140b and hub encase the springs and switch.

In one embodiment, peak holes are provided to allow inspectors to verify that the closed mechanism is assembled correctly. In one embodiment, for example, the outer lid 140b has 8 peak holes thereon so that an assembly line inspector can ensure that the springs are in place after the package has been sealed. In one embodiment, the 8 peak holes are placed such that there are 4 peak holes for each spring, each hole at a key point. It should be appreciated that other means can be adopted for providing the inspector with means for verifying the assembly. For example, the lids can be made up of material which is transparent in some or all areas. In one embodiment, each lid is attached via two screws. In one embodiment, the inner lid 140a is attached at the inner cylinder of the nylon base 130, while the outer lid 140b is attached to the hub. The outer lid is further attached to the TV stand arm along with the hub. According to one embodiment, the inner lid rotates with the screen, as the outer lid remains stationary with the hub and TV stand arm.

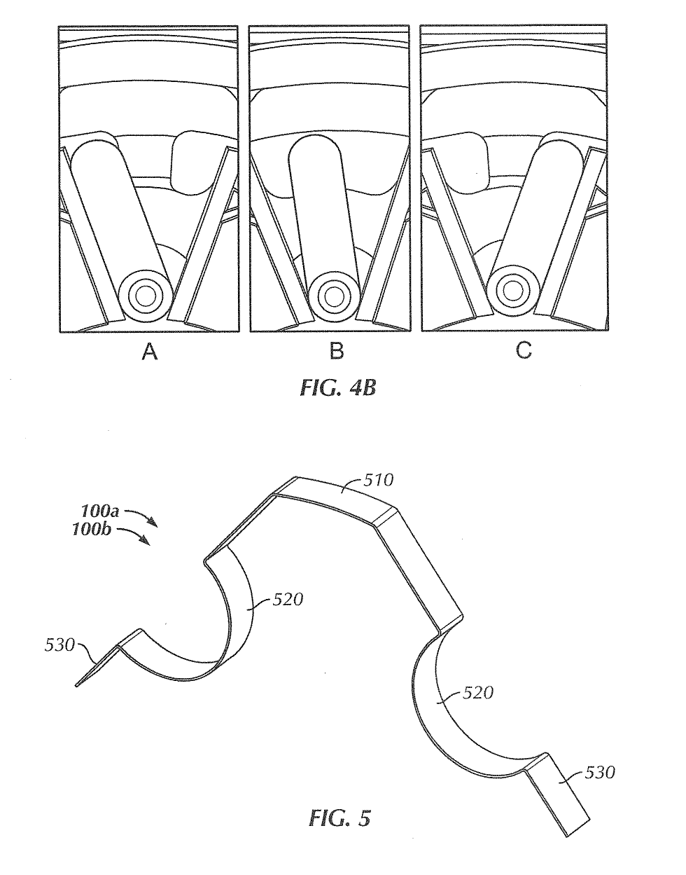

FIGS. 6A and 6B illustrates the mechanism as attached to the screen and the arm assembly. As illustrated, the nylon base 130 attaches to display screen 610, and the hub 120 attaches to the arm 620. FIG. 6A illustrates the manner in which the mechanism attaches to the hub 120 and base 130, the lids being transparent, while FIG. 6B illustrates the complete assembled mechanism being attached to the screen 610 and arm 620.

In one embodiment, to accommodate the mechanism the back of the display screen requires four screw holes to accommodate the screws that attach the base to the screen. For example, in one embodiment, the TV screen may be provided with 7 mm deep screw holes to accommodate 4×10 plastic screws. In other embodiments, other means of attachment may be used for attaching the nylon base to the display screen. In one embodiment, the distance between the screw holes at the nylon base used for attachment to the screen may be 88 mm. In some embodiments, the TV stand arm is further attached to the hub via two screw holes. In one embodiment, the screw holes accommodate 3×12 plastic screws. In one embodiment, the screw holes are 50 mm apart. In one embodiment, the outer lid may comprise two cones near the screw holes used to attach the arm to ensure that the TV stand arm is attached correctly. In such embodiments, the stand arm may also have negative holes to match the cones on the outer lid ensuring the mechanism is attached right side up.

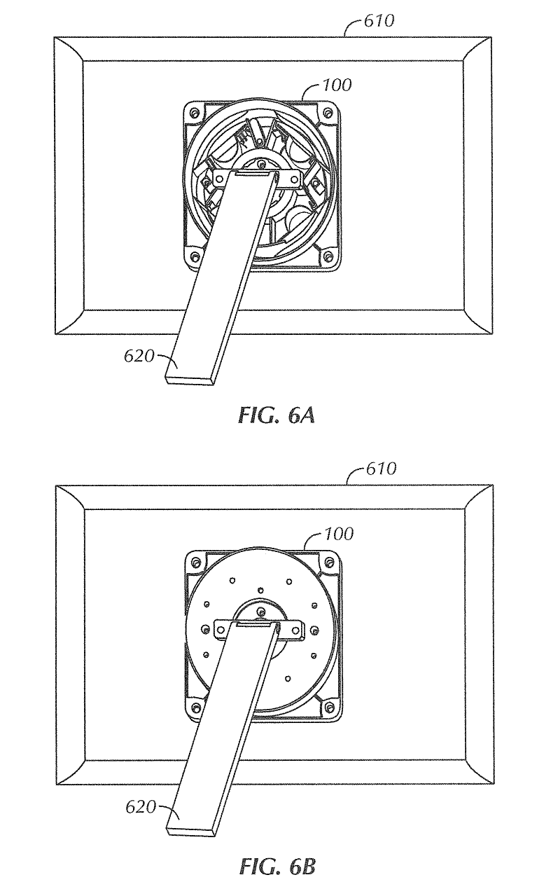

As illustrated in FIG. 7, in some embodiments, the swivel mechanism 100 may further comprise an axial channel to provide passage for cabling. In one embodiment, the channel is wide enough to fit a variety of cables of different sizes. In one exemplary embodiment, the mechanism has an axial channel wide enough to fit a 15 mm wide cable. For example, the channel is a 16 mm wide channel. The edges at either end of the channel may have radii to prevent chaffing of the cables.

While the invention herein disclosed has been described by means of specific embodiments, examples and applications thereof, numerous modifications and variations could be made thereto by those skilled in the art without departing from the scope of the invention set forth in the claims.

What is claimed is:

1. A swivel mechanism, comprising:
a base configured to be attached to a screen and further configured to rotate with the screen as the screen is rotated;
a hub configured to fit into the base and remain stationary as the screen and the base are rotated; and
two springs configured to be set into the hub and configured to compress to provide a resistance torque as the screen is rotated.

2. The swivel mechanism of claim 1, the hub being further configured to attach to a stand arm.

3. The swivel mechanism of claim 1, wherein the two springs each comprise:
a top surface configured to traverse an inner portion of the base as the screen is rotated;
semicircular sections configured to compress as the screen is rotated; and
arms for being set into the hub.

4. The swivel mechanism of claim 1, wherein the base comprises a groove extending around the base, the groove having a break therein.

5. The swivel mechanism of claim 4, wherein the break is configured to limit a rotational freedom of the hub to 360 degrees.

6. The swivel mechanism of claim 5, wherein the hub comprises a switch extending into the groove and configured to further limit the rotational freedom to 360 degrees.

7. The swivel mechanism of claim 1, the base comprising an outer cylindrical portion and inner cylindrical portion being concentric, wherein the hub fits into an opening between the inner cylindrical portion and the outer cylindrical portion.

8. The swivel mechanism of claim 7, wherein the outer cylindrical portion of the base comprises an inner wall comprising:
a plurality of snap to points at which the screen will snap to position as the screen rotates placed at 90 degree intervals;
a plurality of steady state travel surfaces; and
a plurality of transition surfaces providing a transition between each of the plurality of steady state travel surfaces and each of the plurality of snap to points.

9. The swivel mechanism of claim 8, wherein spring compression is constant as rotate across each of the plurality of steady state travel surfaces.

10. The swivel mechanism of claim 8, wherein a spring compression of one or both of the two springs is configured to change with the position of the one or both of the two springs as the one or both of the two springs traverse each of the plurality of transition surfaces.

11. The swivel mechanism of claim 8, wherein the base comprises four steady state travel surfaces and eight transition surfaces.

12. The swivel mechanism of claim 7, further comprising:
a first lid configured to attach to the inner cylindrical portion.

13. The swivel mechanism of claim 7, further comprising:
a second lid configured to attach to the hub and extending the opening between the inner cylindrical portion and the outer cylindrical portion and configured to cover the hub and the two springs.

14. The swivel mechanism of claim 13, wherein the second lid comprises peak holes to allow monitoring of the hub and the two springs after the second lid has been fixed to the hub.

15. The swivel mechanism of claim 1, wherein the base is made from nylon material.

16. The swivel mechanism of claim 1, wherein the base is configured to rotate when the screen is rotated, while the hub remains stationary.

17. The swivel mechanism of claim 1, further comprising an axial channel configured to provide a passage for cabling.

18. The swivel mechanism of claim 1, wherein the hub comprises one or more walls configured to hold the two springs in place.

19. The swivel mechanism of claim 1, wherein the resistance torque is configured to equal approximately 1500 N-mm.

20. A method of assembling a swivel mechanism comprising:
providing a base having an outer cylindrical wall and an inner cylindrical wall being concentric;
providing a hub;
providing two springs;
setting the hub into an opening created between the inner cylindrical wall and the outer cylindrical wall of the base; and
setting the two springs into the hub such that each spring is placed at one side of the hub.

21. The method of claim 20, further comprising:
placing a first lid at a connection point between the inner cylindrical wall of the base and the hub; and
placing a second lid over portions of the hub not covered by the first lid and the outer cylindrical wall of the base.

22. The method of claim 20, further comprising:
attaching the swivel mechanism to a screen such that the base rotates with the screen and further such that one or both of the two springs are configured to compress as the screen rotates to provide a resistance torque.

23. The method of claim 20, further comprising:
attaching the swivel mechanism to an arm.
